(19) United States
(12) Patent Application Publication
(10) Pub. No.: US 2025/0041634 A1
(43) Pub. Date: Feb. 6, 2025

(54) WEARABLE AIR PURIFIER ASSEMBLY AND AIR PURIFIER THEREOF

(71) Applicant: Tien-Tse Hsieh, Tainan City (TW)

(72) Inventor: Tien-Tse Hsieh, Tainan City (TW)

(21) Appl. No.: 18/788,014

(22) Filed: Jul. 29, 2024

Related U.S. Application Data
(60) Provisional application No. 63/530,107, filed on Aug. 1, 2023.

(51) Int. Cl. A62B 18/00; A62B 23/02; B01D 46/12; F24F 8/80

(52) U.S. Cl. CPC A62B 18/00; A62B 23/02; B01D 46/12; F24F 8/80; B01D 2265/023; B01D 2275/10; B01D 2279/45

(57) ABSTRACT

A wearable air purifier assembly includes a wearable member, a first air purifier, and a second air purifier. The first air purifier and the second air purifier are detachably connected to two opposing sides of the wearable member and each have a separate use mode and a connected use mode. When in the separate use mode, the first air purifier and the second air purifier are separated from the wearable member and used independently for supplying filtered air. When in the connected use mode, the first air purifier and the second air purifier are connected to the wearable member and can be adjusted through an adjustment module to a desired use direction for supplying the filtered air to a desired position. The wearable air purifier assembly provides different use modes, not limited to wearable use, increasing the flexibility of product use.

### CROSS REFERENCE TO RELATED APPLICATIONS

This application claims the benefit of U.S. Provisional Application No. 63/530,107, filed Aug. 1, 2023.

### FIELD OF THE INVENTION

The present invention relates to an air purifier, and more particularly to a wearable air purifier assembly and an air purifier thereof.

### BACKGROUND OF THE INVENTION

Air pollution is a growing problem. Many people wear face masks or use air purifiers to avoid inhaling hazardous substances in the air.

However, wearing a face mask is uncomfortable. The user may feel hot or stuffy. Therefore, face masks are not suitable for users who engage in outdoor sports, leisure activities, or those who have sensitive skin. Air purifiers are only suitable for relatively small spaces, such as car's interiors or indoor spaces.

Taiwan Patent Publication No. 1750952 discloses a portable air purifier. The portable air purifier is designed to be easy to wear and use for a user. However, the user has to wear the portable air purifier, which restricts the way of use. The use of the portable air purifier is not flexible enough.

### SUMMARY OF THE INVENTION

The primary object of the present invention is to provide a wearable air purifier assembly and an air purifier thereof, which can enhance the convenience and flexibility of the product use.

According to one aspect of the present invention, a wearable air purifier assembly is provided. The wearable air purifier assembly includes a wearable member, a first air purifier, and a second air purifier. The first air purifier and the second air purifier are detachably connected to two opposing sides of the wearable member and each have a separate use mode and a connected use mode. When in the separate use mode, the first air purifier and the second air purifier are separated from the wearable member and used independently for supplying filtered air. When in the connected use mode, the first air purifier and the second air purifier are connected to the wearable member and an air supply direction of the filtered air is adjustable through an adjustment module of each of the first air purifier and the second air purifier.

Preferably, the first air purifier and the second air purifier each include a body and a cover. The cover is rotatably mounted to the body. The cover has an air outlet. The cover is rotatable for adjusting the air outlet. Preferably, the body includes a swivel seat. The cover is detachably secured to the swivel seat in a magnetic attraction manner. A filter is provided between the swivel seat and the cover.

Preferably, the wearable air purifier assembly further includes an air guide member. The air guide member is detachably mounted to the cover. The air guide member has a tapered air guide passageway corresponding to the air outlet.

Preferably, the length of the wearable member is adjustable. The first air purifier and the second air purifier are rotatably mounted to the wearable member.

Preferably, the first air purifier and the second air purifier are electrically connected to an electronic device of the wearable member, and the junction may be equipped with a multi-directional retaining structure.

According to another aspect of the present invention, an air purifier is provided. The air purifier is detachably connected to a first side or a second side of a wearable member. The air purifier includes a detachable coupling portion and an adjustment module. The air purifier is detachably connected to the first side or the second side of the wearable member through the detachable coupling portion, thereby having a separate use mode and a connected use mode. When in the separate use mode, the air purifier is separated from the wearable member and used independently for supplying filtered air. When in the connected use mode, the air purifier is connected to the wearable member and an air supply direction of the filtered air is adjusted through the adjustment module to a first side use direction corresponding to the first side or to a second side use direction corresponding to the second side.

With the above technical features, the present invention can achieve the following effects:
1. The air purifier of the wearable air purifier assembly has a separate use mode and a connected use mode, thereby providing different use modes, not limited to wearable use. When in the separate use mode, the air purifier may be placed in any position (such as on the table, in the car, hand-held, etc.), and they may be secured on baby strollers, wheelchairs, safety helmets, computers and other places by means of clamps, so as to increase the flexibility of use.
2. The first air purifier and the second air purifier of the wearable air purifier assembly can be used in both left and right sides, and they are not limited to a specific installation position, increasing the convenience of installation and use. It is easier to manufacture products.
3. The cover of the air purifier is secured in a magnetic attraction manner, which can be mounted and dismounted with ease, allowing users to replace the filter by themselves.
4. The wearable member itself and the connecting portion of the wearable member and the air purifier are designed to be adjustable, making it easy for the user to make adjustments according to their own needs.
5. The first air purifier and the second air purifier are electrically connected to the electronic device of the wearable member. The electronic device may be, for example, a temperature control module, a music module or a charging and discharging module, etc., which can make the functions of the product more diverse.
6. The electrical connection portions of the first air purifier, the second air purifier and the wearable member have a multi-directional retaining structure to form a stable connection relationship, thereby ensuring the stability of the electrical connection effectively.
7. The air guide member is gradually tapered, thereby guiding the filtered air to the user's mouth and nose better.

### BRIEF DESCRIPTION OF THE DRAWINGS

FIG. 1 is a perspective view according to a preferred embodiment of the present invention;

FIG. 2 is an exploded view according to the preferred embodiment of the present invention;

FIG. 3 is a planar schematic view according to the preferred embodiment of the present invention;

FIG. 4 is a planar schematic view according to the preferred embodiment of the present invention, wherein the length of the wearable member is adjusted;

FIG. 5 is a partial perspective view according to the preferred embodiment of the present invention, wherein the air purifier is rotated;

FIG. 6 is a partial cross-sectional, exploded view illustrating the connecting portion and the detachable coupling portion according to the preferred embodiment of the present invention;

FIG. 7 is a partial cross-sectional view illustrating the connecting portion and the detachable coupling portion according to the preferred embodiment of the present invention;

FIG. 8 is an exploded view of the air purifier according to the preferred embodiment of the present invention;

FIG. 9 is a perspective view of the air purifier according to the preferred embodiment of the present invention, wherein the air outlet is adjusted;

FIG. 10 is an exploded view according to the preferred embodiment of the present invention in cooperation with the air guide member; and

FIG. 11 is a perspective view according to the preferred embodiment of the present invention in cooperation with the air guide member.

### DETAILED DESCRIPTION OF THE PREFERRED EMBODIMENTS

Embodiments of the present invention will now be described, by way of example only, with reference to the accompanying drawings.

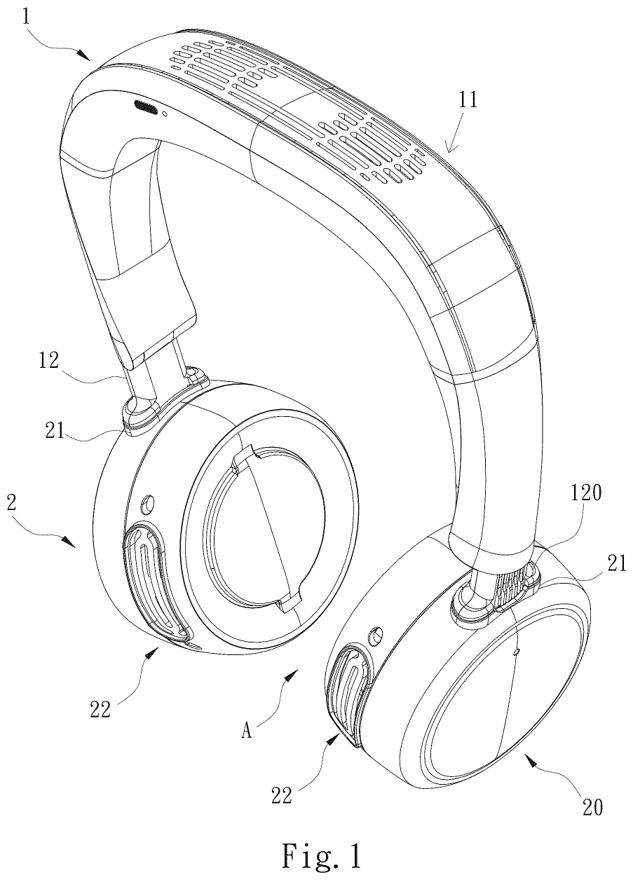

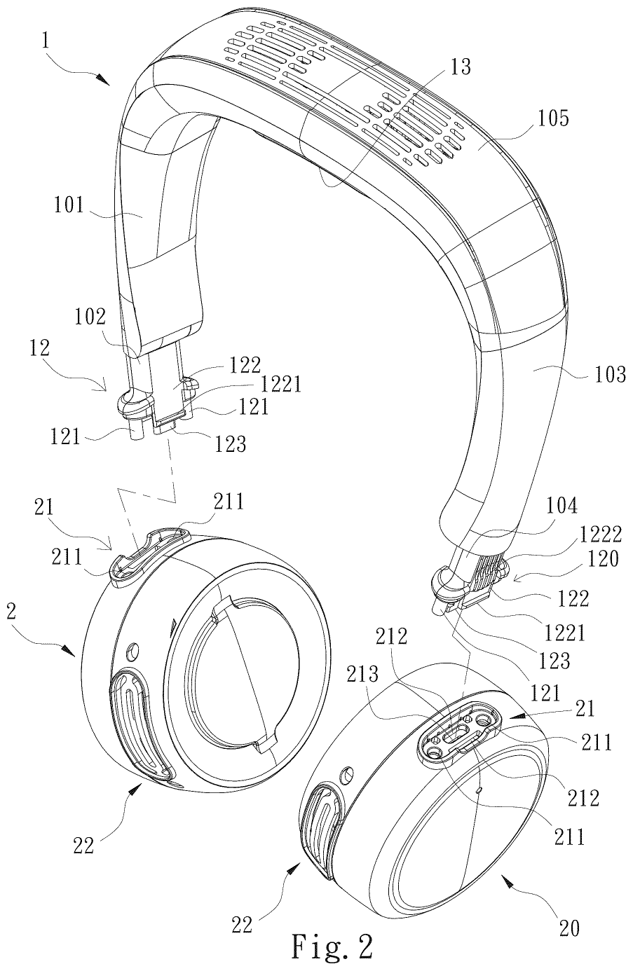

The present invention discloses a wearable air purifier assembly and an air purifier thereof. Referring to FIG. 1 and FIG. 2, a wearable air purifier assembly according to an embodiment of the present invention includes a wearable member (1), a first air purifier (2), and a second air purifier (20). The wearing member (1) includes a wearing portion (11), a first connecting portion (12), and a second connecting portion (120). The first connecting portion (12) and the second connecting portion (120) are located on a first side and an opposing second side of the wearing portion (11), respectively. An air supply area (A) is defined between the first side and the second side.

The first air purifier (2) and the second air purifier (20) are detachably mounted to the first side and the second side of the wearing member (1) respectively through a detachable coupling portion (21), thus having a separate use mode (shown in FIG. 2) and a connected use mode (shown in FIG. 1). When in the separate use mode, the first air purifier (2) and the second air purifier (20) are separated from the wearable member (1) and used independently for supplying filtered air. The first air purifier (2) and the second air purifier (20) may be placed in any position (such as on the table, in the car, hand-held, etc.), and they may be secured on baby strollers, wheelchairs, safety helmets, computers and other places by means of clamps, so as to increase the flexibility of use. When in the connected use mode, the first air purifier (2) and the second air purifier (20) are connected to the wearable member (1) and are adjustable through an adjustment module (22) for adjusting the air supply direction to a first side use direction corresponding to the first side or a second side use direction corresponding to the second side, so as to facilitate left and right interchangeability and improve the convenience of manufacture, use and installation.

It should be noted that in this embodiment, the first connecting portion (12) and the second connecting portion (120) as well as the first air purifier (2) and the second air purifier (20) are substantially relative to each other. For simplicity, the first connecting portion (12) and the second connecting portion (120) may be referred to as the connecting portion, and the first air purifier (2) and the second air purifier (20) may be referred to as the air purifier. In the following detailed description of the configurations of the first connecting portion (12), the second connecting portion (120), the first air purifier (2) and the second air purifier (20), the first and the second will not be described as a distinction between the first and the second, but will be described by using the same or similar component terms and component symbols. However, it should be noted that the implementation is not limited to the same configuration.

Referring to FIG. 2, the wearable member (1) may be integrally formed of a single material (such as a flexible material) or composed of multiple components. In this embodiment, the wearable member (1) includes a first arm (101), a first mounting seat (102), a second arm (103), a second mounting seat (104), and a connecting body (105). The first arm (101) is connected to one end of the connecting body (105). The first mounting seat (102) is mounted to the first arm (101). The first connecting portion (12) is located on the first mounting seat (102). The second arm (103) is connected to the other end of the connecting body (105). The second mounting seat (104) is mounted to the second arm (103). The second connecting portion (120) is located on the second mounting seat (104).

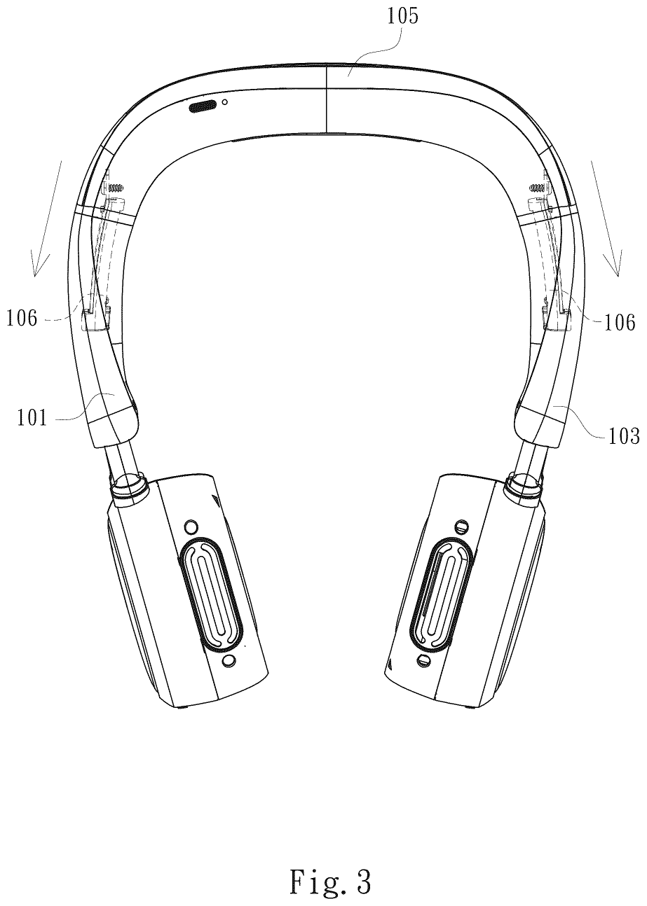

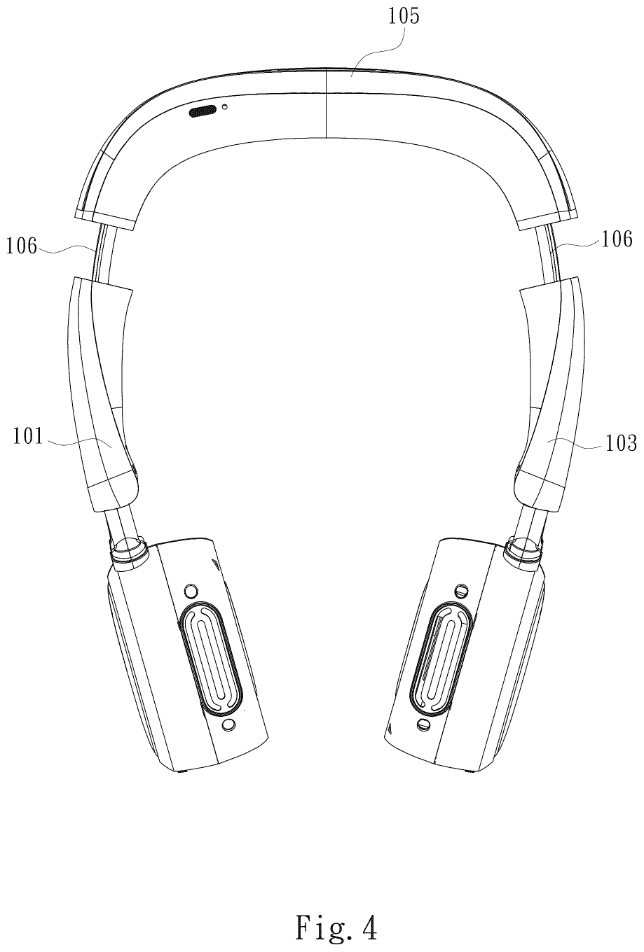

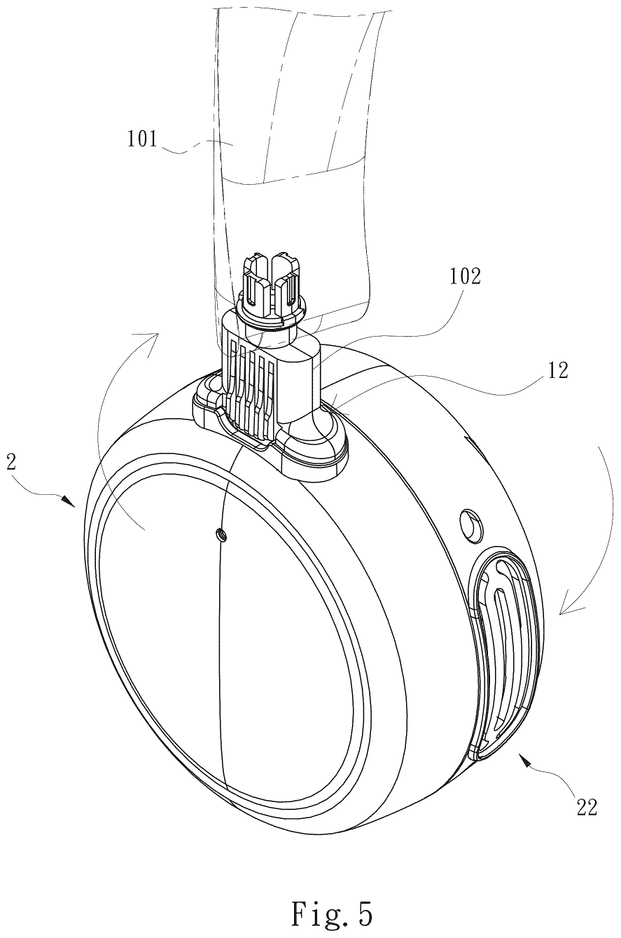

Referring to FIG. 3 and FIG. 4, in this embodiment, the first arm (101) and the second arm (103) are movably connected to two sides of the connecting body (105). For example, the first arm (101) and the second arm (103) are respectively sleeved on two supports (106) of the connecting body (105), thereby lengthening or shortening the total length of the first arm (101) and the second arm (103) relative to the connecting body (105). Referring to FIG. 5 in cooperation with FIG. 2, the first mounting seat (102) is rotatably mounted to one end of the first arm (101). The angle of the first connecting portion (12) can be adjusted by rotating the first mounting seat (102). In this embodiment, the second mounting seat (104) also has the same rotatable configuration. Thereby, the first air purifier (2) can provide multi-directional adjustments through the first arm (101), the first mounting seat (102) and the adjustment module (22). Similarly, the second air purifier (20) can provide multi-directional adjustments through the second arm (103), the second mounting seat (104) and the adjustment module (22), so that the direction of air supply can be flexibly adjusted according to the needs of different users.

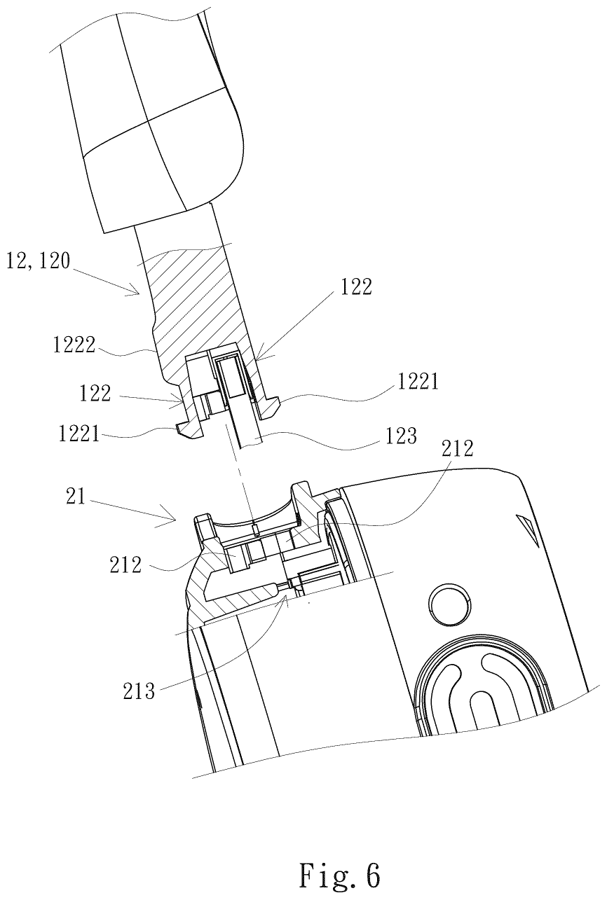

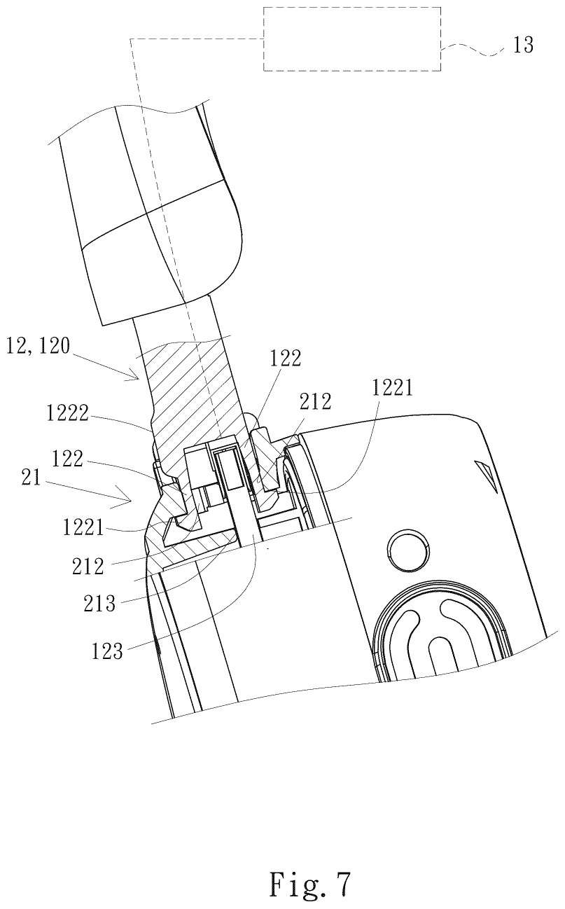

Referring to FIG. 2, the first connecting portion (12) and the second connecting portion (120) each have a plurality of guide posts (121) and a plurality of clastic locking portions (122). The clastic locking portion (122) has a locking end (1221) and an operating portion (1222). The operating portion (1222) is adjacent to the locking end (1221). The detachable coupling portion (21) has a plurality of guide grooves (211) and a locking groove (212). The guide grooves (211) and the locking groove (212) correspond to the guide posts (121) and the clastic locking portions (122), respectively. The guide grooves (211) are configured for insertion of the guide posts (121). A detachable electrical connector is provided between the first connecting portion (12) and the detachable coupling portion (21) and between the second connecting portion (120) and the detachable coupling portion (21). The detachable electrical connector may be a concave-convex fit structure. For example, the detachable coupling portion (21) has an electrical connection slot (213). The electrical connection slot (213) corresponds in position to one of the locking grooves (212). The first connecting portion (12) and the second connecting portion (120) each have an electrical connection end (123) corresponding to the electrical connection slot (213). Referring to FIG. 6 and FIG. 7, the locking ends (1221) of the elastic locking portions (122) are inserted and engaged in the locking groove (212). The locking ends (1221) of the clastic locking portions (122) may be disengaged from the locking groove (212) by pressing the operating portion (1222). The electrical connection end (123) is inserted into the electrical connection slot (213), thereby supplying power to an electronic device (13). The electronic device (13) may be, for example, a temperature control module, a music module, a charging and discharging module, etc. In this embodiment, the electronic device (13) takes a temperature control module of a cooling chip assembly as an example, and it may be disposed on the inner edge of the connecting body (105), as shown in FIG. 2. Referring to FIG. 7 and FIG. 2, because the first connecting portion (12), the second connecting portion (120) and the detachable coupling portion (21) are connected through the guide posts (121) and the elastic locking portions (122) to form a multi-directional retaining structure, the detachable electrical connector forms a stable connection relationship, thereby ensuring the stability of the electrical connection effectively.

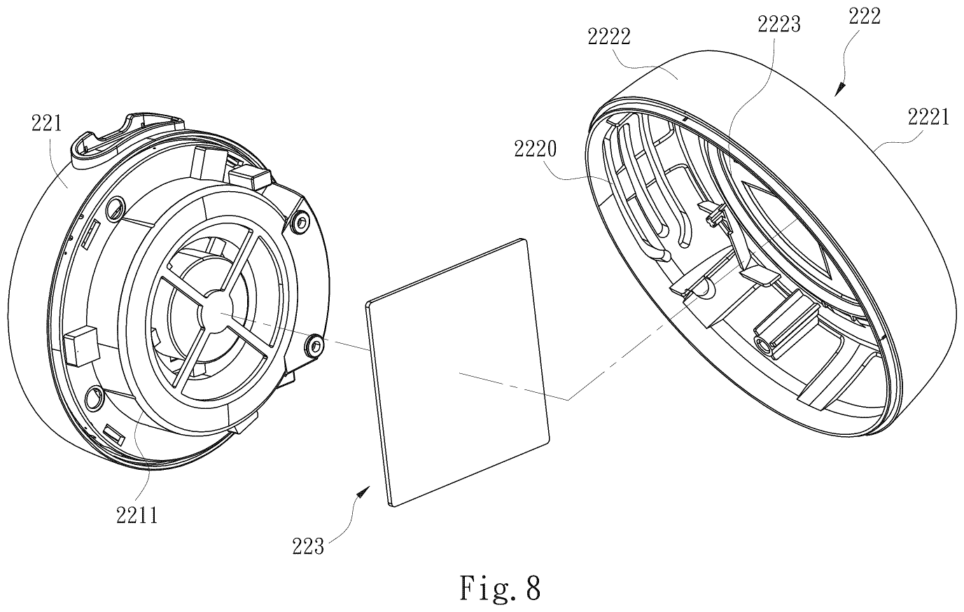

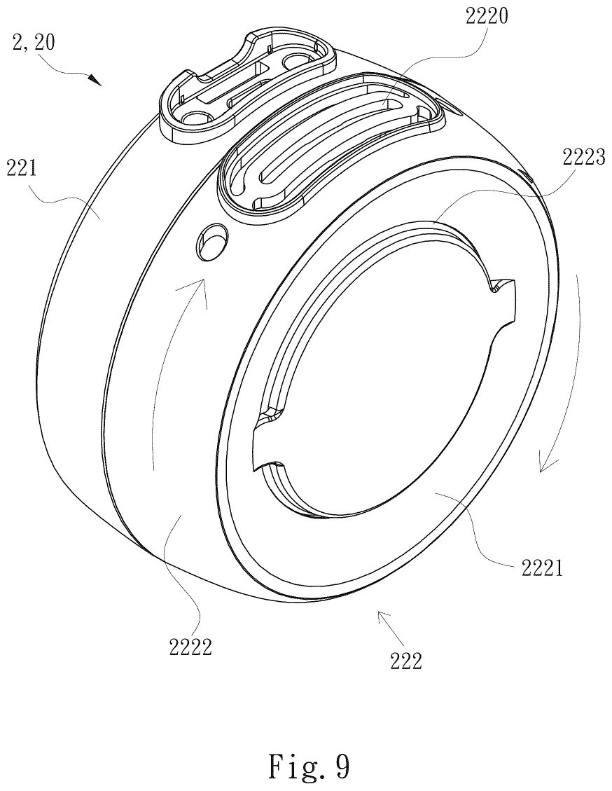

Referring to FIG. 8 and FIG. 9, the air purifier (2) (20) (i.e., the first air purifier or the second air purifier) includes a body (221) and a cover (222). The cover (222) is rotatably mounted to the body (221). The cover (222) has an air outlet (2220). The cover (222) is rotatable for adjusting the air supply direction of the air outlet (2220). In this embodiment, the body (221) includes a swivel seat (2211). The swivel seat (2211) is a swivel seat having a 360-degree swivel function. The cover (222) is detachably secured to the swivel seat (2211) in a magnetic attraction manner. The air supply direction of the air outlet (2220) can be adjusted by rotating the swivel seat (2211) and the cover (222) synchronously. A filter (223) is sandwiched between the swivel seat (2211) and the cover (222). The filter (223) in the form of plural platy filter layers is pre-packaged to provide a better filtration effect and easy installation and use. The filter (223) can be replaced easily because the cover (222) is secured in a magnetic attraction manner. Specifically, the cover (222) has a face (2221) and a circumferential side (2222) surrounding the face (2221). The face (2221) has an air inlet (2223). The air inlet (2223) corresponds to the filter (223). The air outlet (2220) is located on the circumferential side (2222). The air outlet (2220) communicates with the air inlet (2223). The configuration of the air inlet and the air outlet prevents the user's hair from being sucked in the air purifier when in use, thereby increasing the safety of product use.

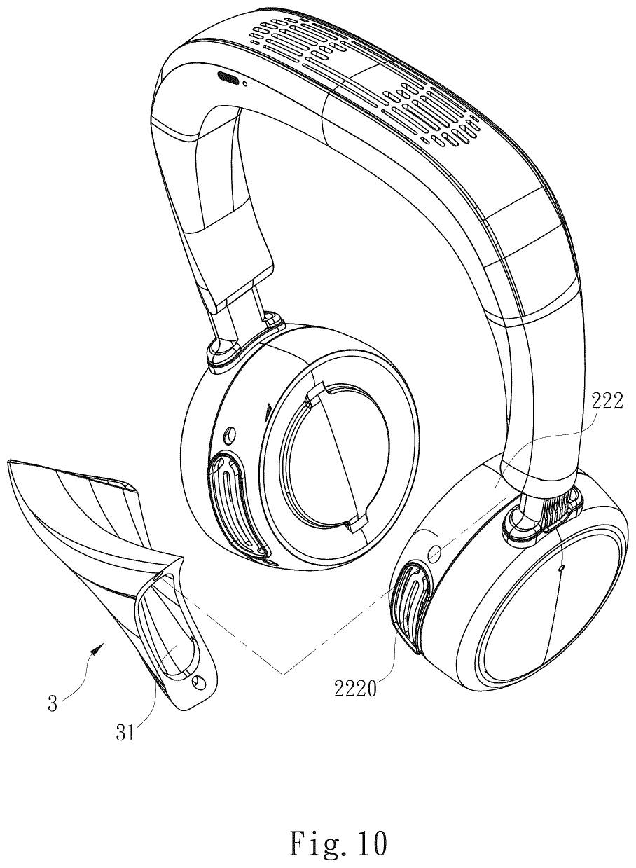

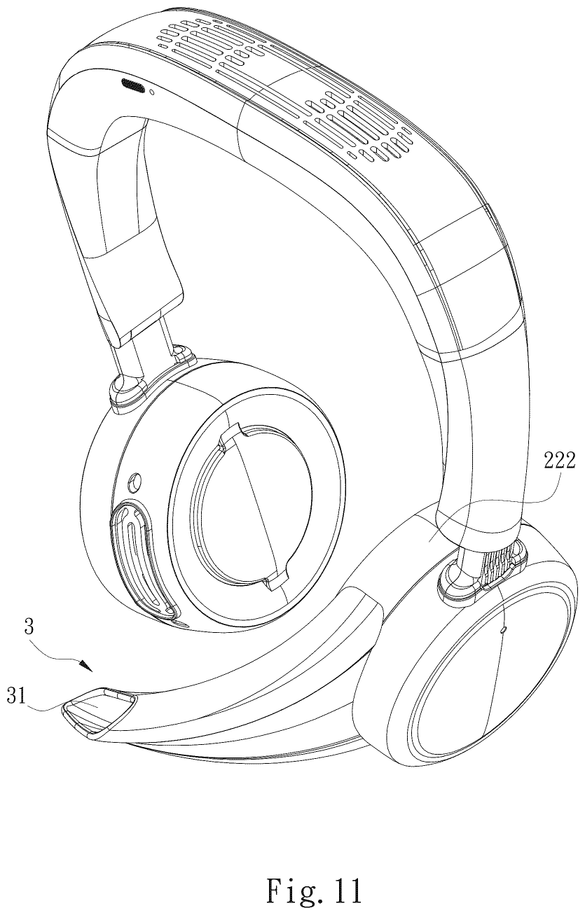

Referring to FIG. 10 and FIG. 11, the wearable air purifier assembly according to the embodiment of the present invention further includes an air guide member (3). The air guide member (3) is detachably mounted to the cover (222) in a concave-convex fit or magnetic attraction manner. The air guide member (3) has an air guide passageway (31) corresponding to the air outlet (2220). The air guide passageway (31) is gradually tapered to guide the filtered air to the user's mouth and nose better.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wearable air purifier assembly, comprising:
a wearable member, comprising a wearing portion, a first connecting portion and a second connecting portion, the first connecting portion and the second connecting portion being located on a first side and an opposing second side of the wearing portion respectively, an air supply area being defined between the first side and the second side;
a first air purifier, comprising a first detachable coupling portion and a first adjustment module, the first air purifier being detachably connected to the first connecting portion through the first detachable coupling portion, thereby having a first separate use mode and a first connected use mode, wherein when in the first separate use mode, the first air purifier is separated from the wearable member and used independently for supplying first filtered air; wherein when in the first connected use mode, the first air purifier is connected to the wearable member and a first air supply direction of the first filtered air is adjusted through the first adjustment module to a first side use direction of the air supply area;
a second air purifier, comprising a second detachable coupling portion and a second adjustment module, the second air purifier being detachably connected to the second connecting portion through the second detachable coupling portion, thereby having a second separate use mode and a second connected use mode, wherein when in the second separate use mode, the second air purifier is separated from the wearable member and used independently for supplying second filtered air;
wherein when in the second connected use mode, the second air purifier is connected to the wearable member and a second air supply direction of the second filtered air is adjusted through the second adjustment module to a second side use direction of the air supply area.

2. The wearable air purifier assembly as claimed in claim 1, wherein the first air purifier and the second air purifier each include a body and a cover, the cover is rotatably mounted to the body, the cover has an air outlet, and the cover is rotatable for adjusting the air outlet to correspond to the first side use direction or the second side use direction.

3. The wearable air purifier assembly as claimed in claim 2, wherein the body includes a swivel seat, the cover is detachably mounted to the swivel seat, and a filter is provided between the swivel seat and the cover.

4. The wearable air purifier assembly as claimed in claim 3, wherein the cover is detachably secured to the swivel seat in a magnetic attraction manner.

5. The wearable air purifier assembly as claimed in claim 3, wherein the cover has a face and a circumferential side surrounding the face, the face has an air inlet, the air inlet corresponds to the filter, the air outlet is located on the circumferential side, and the air outlet communicates with the air inlet.

6. The wearable air purifier assembly as claimed in claim 5, further comprising an air guide member, the air guide member being detachably mounted to the cover, the air guide member having a tapered air guide passageway corresponding to the air outlet.

7. The wearable air purifier assembly as claimed in claim 1, wherein the wearable member includes a first arm, a first mounting seat, a second arm, a second mounting seat and a connecting body, the first arm is movably connected to one end of the connecting body, thereby lengthening or shortening a total length of the first arm and the connecting body, the first mounting seat is rotatably mounted to the first arm, the first connecting portion is located on the first mounting seat, the first connecting portion is adjustable in angle by rotating the first mounting seat, the second arm is movably connected to another end of the connecting body, thereby lengthening or shortening a total length of the second arm and the connecting body, the second mounting seat is rotatably mounted to the second arm, the second connecting portion is located on the second mounting seat, and the second connecting portion is adjustable in angle by rotating the second mounting seat.

8. The wearable air purifier assembly as claimed in claim 7, wherein the first connecting portion has a first guide post and a first elastic locking portion, the first elastic locking portion has a first locking end and a first operating portion, the first operating portion is adjacent to the first locking end for operating the first locking end to be engaged with or disengaged from the first detachable coupling portion; the first detachable coupling portion has a first guide groove and a first locking groove, the first guide groove is configured for insertion of the first guide post, the first locking groove is configured for insertion of the first elastic locking portion, and the first locking end is engageable with the first detachable coupling portion.

9. The wearable air purifier assembly as claimed in claim 1, wherein a detachable electrical connector is provided between the first connecting portion and the first detachable coupling portion, and the detachable electrical connector is a concave-convex fit structure.

10. The wearable air purifier assembly as claimed in claim 9, wherein the wearable member includes an electronic device, and the electronic device is electrically connected to the detachable electrical connector.

11. The wearable air purifier assembly as claimed in claim 7, wherein the second connecting portion has a second guide post and a second elastic locking portion, the second elastic locking portion has a second locking end and a second operating portion, the second operating portion is adjacent to the second locking end for operating the second locking end to be engaged with or disengaged from the second detachable coupling portion; the second detachable coupling portion has a second guide groove and a second locking groove, the second guide groove is configured for insertion of the second guide post, the second locking groove is configured for insertion of the second elastic locking portion, and the second locking end is engageable with the second detachable coupling portion.

12. The wearable air purifier assembly as claimed in claim 1, wherein a detachable electrical connector is provided between the second connecting portion and the second detachable coupling portion, and the detachable electrical connector is a concave-convex fit structure.

13. The wearable air purifier assembly as claimed in claim 12, wherein the wearable member includes an electronic device, and the electronic device is electrically connected to the detachable electrical connector.

14. A wearable air purifier assembly, comprising a wearable member, a first air purifier, and a second air purifier; the first air purifier and the second air purifier being detachably connected to two opposing sides of the wearable member and each having a separate use mode and a connected use mode; wherein when in the separate use mode, the first air purifier and the second air purifier are separated from the wearable member and used independently for supplying filtered air; wherein when in the connected use mode, the first air purifier and the second air purifier are connected to the wearable member and an air supply direction of the filtered air is adjustable through an adjustment module of each of the first air purifier and the second air purifier.

15. An air purifier, detachably connected to a first side or a second side of a wearable member, comprising a detachable coupling portion and an adjustment module, the air purifier being detachably connected to the first side or the second side of the wearable member through the detachable coupling portion, thereby having a separate use mode and a connected use mode; wherein when in the separate use mode, the air purifier is separated from the wearable member and used independently for supplying filtered air; wherein when in the connected use mode, the air purifier is connected to the wearable member and an air supply direction of the filtered air is adjusted through the adjustment module to a first side use direction corresponding to the first side or to a second side use direction corresponding to the second side.

16. The air purifier as claimed in claim 15, further comprising a body and a cover, the cover being rotatably mounted to the body, the cover having an air outlet, the cover being rotatable for adjusting the air outlet to correspond to the first side use direction or the second side use direction.

17. The air purifier as claimed in claim 16, wherein the body includes a swivel seat, the cover is detachably mounted to the swivel seat, and a filter is provided between the swivel seat and the cover.

18. The air purifier as claimed in claim 17, wherein the cover is detachably secured to the swivel seat in a magnetic attraction manner.

19. The air purifier as claimed in claim 17, wherein the cover has a face and a circumferential side surrounding the face, the face has an air inlet, the air inlet corresponds to the filter, the air outlet is located on the circumferential side, and the air outlet communicates with the air inlet.

20. The air purifier as claimed in claim 16, further comprising an air guide member, the air guide member being detachably mounted to the cover, the air guide member having a tapered air guide passageway corresponding to the air outlet.
